(19) United States
(12) Patent Application Publication
(10) Pub. No.: US 2025/0162471 A1
(43) Pub. Date: May 22, 2025

(54) SEAT CONTROL APPARATUS AND METHOD

(71) Applicants: HYUNDAI MOTOR COMPANY, Seoul (KR); KIA CORPORATION, Seoul (KR)

(72) Inventors: Ju Hyun Kim, Anyang-si (KR); Du Se Lee, Suwon-si (KR)

(73) Assignees: HYUNDAI MOTOR COMPANY, Seoul (KR); KIA CORPORATION, Seoul (KR)

(21) Appl. No.: 18/752,430

(22) Filed: Jun. 24, 2024

(30) Foreign Application Priority Data
Nov. 21, 2023 (KR) 10-2023-0162499

(51) Int. Cl. B60N 2/02; B60Q 9/00

(52) U.S. Cl. CPC B60N 2/0277; B60Q 9/008

(57) ABSTRACT

A seat control apparatus includes an input device, a driving device, a memory configured to store one or more instructions, and a controller. The instructions are configured to, when being executed by the controller, cause the seat control apparatus to: identify a first current state of a target seat and a second current state of an adjacent seat upon receiving a specified input regarding a position of the target seat through the input device; identify a target state of the target seat corresponding to the specified input; predict a collision possibility of the target seat and the adjacent seat while the target seat is controlled from the first current state to the target state, based on the first current state, the second current state, and the target state; and control the target seat to the target state by using the driving device upon identifying that there is no collision possibility.

### CROSS-REFERENCE TO RELATED APPLICATION

This application claims the benefit of and priority to Korean Patent Application No. 10-2023-0162499, filed on Nov. 21, 2023, the entire contents of which are incorporated herein by reference.

### TECHNICAL FIELD

The present disclosure relates to a seat control apparatus and method. More particularly, the present disclosure relates to predicting whether a collision will occur and deriving an avoidable control method based on a current state and a target state of a plurality of dynamic systems.

### BACKGROUND

As technologies advance, various components in the interior of a vehicle may be operatively connected to each other. In particular, the seat control apparatus may quickly and accurately provide various functions by performing a cooperative control of components for the convenience of a user.

For example, a host vehicle may include a seat that may be moved (e.g., a slide movement, a backrest movement, a leg rest movement, and a folding movement) in a fully automatic manner relative to the front side. The seat may be automatically moved to a specified position when a situation, such as a single user input (e.g., a switch input) and/or a specified event (e.g., a door opening or closing situation) is identified.

For example, upon receiving a specified input (e.g., a touch input) from a user, a seat control apparatus may move a plurality of seats in a host vehicle to a designated location. As an example, the seat control apparatus may receive and store a specific seat state from the user based on an Integrated memory system (IMS), and upon receiving a specified input, it may control at least some of the plurality of seats to the stored state. These seats may be defined as memory seats.

When the seat control apparatus moves the seats by using driving devices corresponding to the seats after receiving a specified input from the user, an interference (or a collision) may occur between the seats. In particular, when users seated in the host vehicle have changed the seat backrest from its standard position or changed a slide position, there is a possibility of the seats colliding with one another in the process of controlling the seats to the specified state.

The statements in this section merely provide background information related to the present disclosure and may not constitute prior art.

### SUMMARY

The present disclosure has been made to solve the above-mentioned problems occurring in the prior art while advantages achieved by the prior art are maintained intact.

An aspect of the present disclosure provides a seat control apparatus and method, by which, when a specified input is received from a user, a current state of an adjacent system (e.g., a front seat or a rear seat) of a dynamic system (e.g., a seat) corresponding to the specified input may be identified. Additionally, a collision possibility that may occur in a process of controlling the adjacent system to a target state corresponding to the specified input may be controlled.

Another aspect of the present disclosure provides a seat control apparatus and method, by which coordinate data corresponding to current states of a target seat and an adjacent seat and coordinate data corresponding to a target state may be identified and a collision possibility may be predicted based on a comparison result of the coordinate data.

Another aspect of the present disclosure provides a seat control apparatus and method, by which, when coordinate data corresponding to a current state is not identified based on a mapping table, a collision possibility may be predicted based on reference data that are closest to the current state.

Another aspect of the present disclosure provides a seat control apparatus and method, by which, when it is identified that a passenger is seated on an adjacent seat, a collision possibility may be predicted based on another reference that is different from that of a case in which no passenger is seated.

The technical problems to be solved by the present disclosure are not limited to the aforementioned problems. Any other technical problems not mentioned herein should be clearly understood from the following description by those having ordinary skill in the art to which the present disclosure pertains.

According to an aspect of the present disclosure, a seat control apparatus includes: an input device; a driving device; a memory that stores one or more instructions; and a controller operatively connected to the input device, the driving device, and the memory. The instructions may be configured to, when being executed by the controller, cause the seat control apparatus to identify a first current state of a target seat and a second current state of an adjacent seat upon receiving a specified input regarding a position of the target seat through the input device. The instructions may be further configured to cause the seat control apparatus to: identify a target state of the target seat corresponding to the specified input; and predict a collision possibility of the target seat and the adjacent seat while the target seat is controlled from the first current state to the target state, based on the first current state, the second current state, and the target state. The instructions may be further configured to cause the seat control apparatus to: control the target seat to the target state by using the driving device upon identifying that there is no collision possibility.

According to an embodiment, the instructions may be configured to, when being executed by the controller, cause the seat control apparatus to identify first coordinate data of the target seat and second coordinate data of the adjacent seat including at least one of reclining angles, slide positions, folding angles, tilting angles of the target seat and the adjacent seat, or any combination thereof, respectively. Additionally, the instructions may be configured to, when being executed by the controller, cause the seat control apparatus to predict the collision possibility based on a comparison result of the first coordinate data and the second coordinate data.

According to an embodiment, the instructions may be configured to, when being executed by the controller, cause the seat control apparatus to determine that there is a collision possibility when a minimum spacing distance between the target seat and the adjacent seat is a first distance or less while controlling the target seat to the target state, based on the comparison result.

According to an embodiment, the instructions may be configured to, when being executed by the controller, cause the seat control apparatus to identify the first coordinate data and the second coordinate data from a mapping table stored in the memory, based on the first current state and the second current state.

According to an embodiment, the instructions may be configured to, when being executed by the controller, cause the seat control apparatus to identify first reference data and second reference data having the first current state as an intermediate value, from the mapping table when not identifying the first coordinate data from the mapping table. Additionally, the instructions may be configured to, when being executed by the controller, cause the seat control apparatus to identify the collision possibility based on a comparison result of the first reference data, the second reference data, the second coordinate data, and the target state.

According to an embodiment, the instructions may be configured to, when being executed by the controller, cause the seat control apparatus to control the adjacent seat to a specified state and predict the collision possibility again based on the first current state, the specified state, and the target state upon identifying that there is the collision possibility.

According to an embodiment, the instructions may be configured to, when being executed by the controller, cause the seat control apparatus to identify, among avoidance coordinates set not to collide, an avoidance coordinate being closest to the specified state, based on a mapping table stored in the memory, upon identifying that there is the collision possibility. Additionally, the instructions may be configured to, when being executed by the controller, cause the seat control apparatus to control the adjacent seat based on the avoidance coordinate, and control the target seat to the target state.

According to an embodiment, the seat control apparatus may further include an output device. The instructions may be configured to, when being executed by the controller, cause the seat control apparatus to provide a notification regarding disabling of an operation of the target seat by using the output device upon identifying that there is the collision possibility.

According to an embodiment, the seat control apparatus may further include an output device. The instructions may be configured to, when being executed by the controller, cause the seat control apparatus to: provide a warning notification by using the output device upon identifying that a passenger is seated on the adjacent seat; and identify the first current state and the second current state upon receiving an operation request corresponding to the warning notification.

According to an embodiment, the instructions may be configured to, when being executed by the controller, cause the seat control apparatus to determine that there is the collision possibility when predicting that a time point, at which the minimum spacing distance is not more than a second distance that is smaller than the first distance, is present.

According to another aspect of the present disclosure, a seat control method may include: identifying, by a controller, a first current state of a target seat and a second current state of an adjacent seat upon receiving a specified input regarding a position of the target seat through an input device; and identifying, by the controller, a target state of the target seat corresponding to the specified input. The method may further include: predicting, by the controller, a collision possibility of the target seat and the adjacent seat while the target seat is controlled from the first current state to the target state, based on the first current state, the second current state, and the target state. The method may further include controlling, by the controller, the target seat to the target state by using the driving device upon identifying that there is no collision possibility.

According to an embodiment, the seat control method may further include identifying, by the controller, first coordinate data of the target seat and second coordinate data of the adjacent seat including at least one of reclining angles, slide positions, folding angles, tilting angles of the target seat and the adjacent seat, or any combination thereof, respectively. Additionally, the method may include predicting, by the controller, the collision possibility based on a comparison result of the first coordinate data and the second coordinate data.

According to an embodiment, the seat control method may further include determining, by the controller, that there is a collision possibility when a minimum spacing distance between the target seat and the adjacent seat is a first distance or less while controlling the target seat to the target state, based on the comparison result.

According to an embodiment, the seat control method may further include identifying, by the controller, the first coordinate data and the second coordinate data from a mapping table stored in the memory, based on the first current state and the second current state.

According to an embodiment, the seat control method may further include identifying first reference data and second reference data having the first current state as an intermediate value, from the mapping table when not identifying the first coordinate data from the mapping table. The method may also include identifying, by the controller, the collision possibility based on a comparison result of the first reference data, the second reference data, the second coordinate data, and the target state.

According to an embodiment, the seat control method may further include controlling, by the controller, the adjacent seat to a specified state and predicting the collision possibility again based on the first current state, the specified state, and the target state upon identifying that there is the collision possibility.

According to an embodiment, the seat control method may include identifying, by the controller, among avoidance coordinates set not to collide, an avoidance coordinate being closest to the specified state, based on a mapping table stored in the memory, upon identifying that there is the collision possibility. The method may also include controlling, by the controller, the adjacent seat based on the avoidance coordinate, and controlling the target seat to the target state.

According to an embodiment, the seat control method may further include providing, by the controller, a notification regarding disabling of an operation of the target seat by using an output device when identifying that there is the collision possibility.

According to an embodiment, the seat control method may further include providing, by the controller, a warning notification by using an output device when identifying that a passenger is seated on the adjacent seat, and identifying, by the controller, the first current state and the second current state upon receiving an operation request corresponding to the warning notification.

According to an embodiment, the seat control method may further include determining, by the controller, that there is the collision possibility when predicting that a time point, at which the minimum spacing distance is not more than a second distance that is smaller than the first distance, is present.

### BRIEF DESCRIPTION OF THE DRAWINGS

The above and other objects, features, and advantages of the present disclosure should be more apparent from the following detailed description taken in conjunction with the accompanying drawings:

FIG. 1 is a block diagram illustrating components of a seat control apparatus according to an embodiment of the present disclosure;

FIG. 2A is a block diagram illustrating components of a seat control apparatus according to an embodiment of the present disclosure;

FIG. 2B is a block diagram illustrating components of a seat control apparatus according to an embodiment of the present disclosure;

FIG. 3A is a block diagram illustrating components of a seat control apparatus according to an embodiment of the present disclosure;

FIG. 3B is a block diagram illustrating components of a seat control apparatus according to an embodiment of the present disclosure;

FIG. 4 is a view illustrating a graph used by a seat control apparatus to determine a collision possibility according to an embodiment of the present disclosure;

FIG. 5 is a view illustrating a table used by a seat control apparatus to determine a collision possibility according to an embodiment of the present disclosure;

FIG. 6 is a view illustrating a graph used by a seat control apparatus to determine a collision possibility according to an embodiment of the present disclosure;

FIG. 7 is a flowchart describing a seat control method according to an embodiment of the present disclosure;

FIG. 8 is a flowchart describing a seat control method according to an embodiment of the present disclosure;

FIG. 9 is a flowchart describing a seat control method according to an embodiment of the present disclosure; and

FIG. 10 illustrates a computing system related to a seat control apparatus or a seat control method according to an embodiment of the present disclosure.

In relation to the description of the drawings, identical or similar reference numerals may be used for identical or similar components.

### DETAILED DESCRIPTION

Hereinafter, the embodiments of the present disclosure are described in detail with reference to the drawings. In adding the reference numerals to the components of each drawing, it should be noted that the identical or equivalent component is designated by the identical numeral even when it is displayed on other drawings. Further, in describing the embodiments of the present disclosure, a detailed description of well-known features or functions has been ruled out in order not to unnecessarily obscure the gist of the present disclosure.

In describing the components of the embodiments according to the present disclosure, terms such as first, second, “A,” “B,” (a), (b), and the like may be used. These terms are merely intended to distinguish one component from another component, and the terms do not limit the nature, sequence, or order of the constituent components. Unless otherwise defined, all terms used herein, including technical or scientific terms, have the same meanings as those generally understood by those having ordinary skill in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

When a controller, component, device, element, part, unit, module, or the like of the present disclosure is described as having a purpose or performing an operation, function, or the like, the controller, component, device, element, part, unit, or module should be considered herein as being “configured to” meet that purpose or perform that operation or function. Each controller, component, device, element, part, unit, module, and the like may separately embody or be included with a processor and a memory, such as a non-transitory computer-readable media, as part of the apparatus.

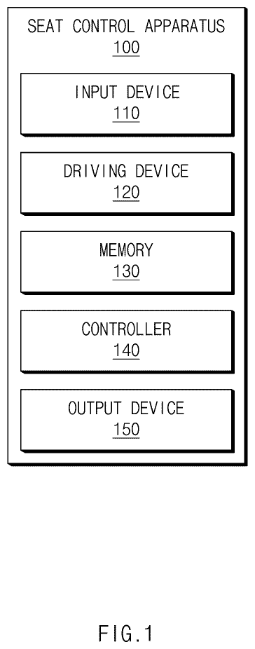

Hereinafter, the embodiments of the present disclosure are described in detail with reference to FIGS. 1-10.

FIG. 1 is a block diagram illustrating components of a seat control apparatus according to an embodiment of the present disclosure.

According to an embodiment, a seat control apparatus 100 may include at least one of an input device 110, a driving device 120, a memory 130, a controller 140, or any combination thereof. A configuration of the seat control apparatus 100 is illustrated in FIG. 1. The embodiments of the present disclosure are not limited thereto. For example, the seat control apparatus 100 may further include components (e.g., at least one of a sensor device, an interface, a communication device, a notification device, or any combination thereof) that are not illustrated in FIG. 1.

According to an embodiment, the input device 110 may include at least one input device that receives a user input to some of components of a host vehicle.

For example, the input device 110 may include at least one of at least one switch, a touchscreen, a voice acquisition device, or any combination thereof.

For example, the input device 110 may be disposed in an area of at least one seat, a center fascia, a back of an assistant seat, and/or an area of a trunk.

For example, the input device 110 may receive a position control input for at least some of the plurality of seats in the host vehicle from a user.

For example, upon receiving a pressure input to the switch, a touch input to the touchscreen, and/or a voice input to the voice acquisition device from the user, the seat control apparatus 100 may perform a seat position control corresponding to the corresponding input.

As an example, the seat control apparatus 100 may receive a specified input regarding a position control of a target seat from the user through the input device 110. The specified input, for example, may include a user input that requests the user to control a position of a seat to a state predefined or a specific state corresponding to the input device 110.

According to an embodiment, the driving device 120 may include a plurality of driving devices that adjust the position (or state) of the seat.

For example, the driving device 120 may mean the seat itself. In other words, the driving device 120 is a dynamic system itself of a seat, of which at least one of a reclining angle (or a backrest angle), a slide position, a headrest angle, a leg rest angle, a swivel angle, or any combination thereof is adjustable.

For example, the driving device 120 may include a first driving device corresponding to, among a plurality of seats arranged in the host vehicle, the target seat. The first driving device, for example, may include a tilting motor that adjusts a tilting angle of the target seat, a reclining motor that adjusts a backrest angle of the target seat, a leg rest motor that adjusts a leg rest angle of the target seat, a slide motor that controls a slide position of the target seat, or any combination thereof.

For example, the controller 140 may perform a slide control for moving the target seat forward and rearward by using the driving device 120. Alternatively, the controller 140 may perform a swivel control for rotating the target seat by a specified angle within 360 degrees based on a vertical axis.

For example, the driving device 120 may include a plurality of driving devices corresponding to a plurality of seats, respectively. As an example, the driving device 120 may include a first driving device corresponding to the target seat and a second driving device corresponding to an adjacent seat (or a rear and/or a front seat of the target seat) that is adjacent to the target seat.

According to an embodiment, the memory 130 may store commands or data. For example, the memory 130 may store one or more instructions that, when being executed by the controller 140, cause the seat control apparatus 100 to perform various operations.

For example, the memory 130 and the controller 140 may be implemented as one chipset. The controller 140 may include at least one of a communication processor or a modem.

For example, the memory 130 may store a designated seat position (or seat state). As an example, the memory 130 may store information on the position (or state) of each of a plurality of seats set by the user. The memory 130 may store the state (e.g., a rotation direction, revolutions per minute (rpm), a pulse) of the driving device 120 corresponding to the designated seat position.

For example, the memory 130 may store a mapping table regarding collision possibilities of the seats depending on the states of the seats. As an example, the mapping table may include coordinate data corresponding to a current state of the target seat and coordinate data corresponding to a current state of the adjacent seat. The mapping table may include information on whether a collision will occur between the target seat and the adjacent seat in a process of controlling the target seat from the current state to the target state, considering the current state of the adjacent state.

According to an embodiment, the controller 140 may be operatively connected to at least one of the input device 110, the driving device 120, the memory 130, or any combination thereof. For example, the controller 140 may control an operation of at least one of the input device 110, the driving device 120, the memory 130, or any combination thereof.

For example, upon receiving a specified input regarding the position control of the target seat through the input device 110, the controller 140 may identify a first current state of the target seat and a second current state of the adjacent seat.

As an example, the adjacent seat may include the front seat and/or the rear seat of the target seat.

As an example, the controller 140 may identify a current state that includes at least one of the reclining angle, the slide position, the folding angle, the tilting angle, or any combination thereof for each of the target seat and the adjacent seat.

As an example, the controller 140 may identify coordinate data corresponding to each of the first current state and the second current state using the mapping table stored in the memory 130. The coordinate data, may include first coordinate data of the target seat and second coordinate data of the adjacent seat.

For example, the controller 140 may identify the target state corresponding to the specified input.

As an example, the controller 140 may identify the target state corresponding to the specified input from some of the information stored in the memory 130. The target position, for example, may include a position (or state) of each of a plurality of seats preset by the user. The target state, for example, may include information on at least one of the backrest angle, the tilting angle, the leg rest angle, the cushion angle, the slide position, or any combination thereof.

As an example, the controller 140 may identify target coordinate data corresponding to the target state by using the mapping table stored in the memory 130.

As an example, the current state may be the position (or state) of each of the seats, which is identified in real time. The current position, for example, may include information on at least one of the backrest angle, the tilting angle, the leg rest angle, the cushion angle, the slide position of the seat, or any combination thereof. The controller 140, for example, may identify the current position of each of the seats through at least one sensor (e.g., a Hall sensor).

For example, the controller 140 may predict a collision possibility of the target seat and the adjacent seat while controlling the target seat from the first current state to the target state based on the first current state, the second current state, and the target state.

As an example, the controller 140 may predict the collision possibility based on a comparison result of first coordinate data and second coordinate data.

For example, upon identifying that there is a time point, at which the minimum spacing distance between the target seat and the adjacent seat is the first distance or less while controlling the target seat to the target state based on the comparison result, the controller 140 may determine that there is a collision possibility.

As an example, upon identifying that a passenger is seated on the adjacent seat, the controller 140 may determine that there is a collision possibility when there is a time point, at which the minimum spacing distance is not more than the second distance that is less than the first distance.

As an example, when not identifying the first coordinate data from the mapping table, the controller 140 may identify first reference data and second reference data that have the first current state as an intermediate value from the mapping table. In this case, the controller 140 may identify (or predict) a collision possibility based on a comparison result of the first reference data, the second reference data, the second coordinate data, and the target state.

For example, upon identifying that there is a collision possibility, the controller 140 may provide a notification regarding disabling of an operation of the target seat by using an output device 150.

For example, upon identifying that there is a collision possibility, the controller 140 may control the adjacent seat to the specified state and predict the collision possibility again based on the first current state, the specified state, and the target state.

As an example, upon identifying that there is a collision possibility again, the controller 140 may identify, among avoidance coordinates that are set not to cause a collision, an avoidance coordinate that is closest to the specified state, based on the mapping table stored in the memory 130. For example, the controller 140 may prevent a collision between the target seat and the adjacent seat by controlling the adjacent seat based on the avoidance coordinate and controlling the target seat to the target state.

For example, when a passenger is seated on the adjacent seat, the controller 140 may provide a warning notification to the user before identifying the current states of the seats.

As an example, the warning notification may include information indicating that a dangerous situation may occur to a passenger during the process of controlling the seat position because the passenger is seated on the adjacent seat.

As an example, after providing the warning notification, the controller 140 may receive an operation request to continue the operation from the passenger and/or the user. The operation request may be a feedback input (e.g., a touch input, a voice input, and/or a gesture input) corresponding to the warning notification through the output device 150. When the operation request is received, the controller 140 may identify the first current state and the second current state and predict a collision possibility.

According to an embodiment, the output device 150 may include at least one of a display device, an audio output device, a haptic device, or any combination thereof.

For example, the controller 140 may output a notification information including at least one of guides of a position, a state, a collision possibility, a control disabling guide, a warning notification, a current state and a target state of the seat corresponding to the driving device 120, or any combination thereof by using the output device 150.

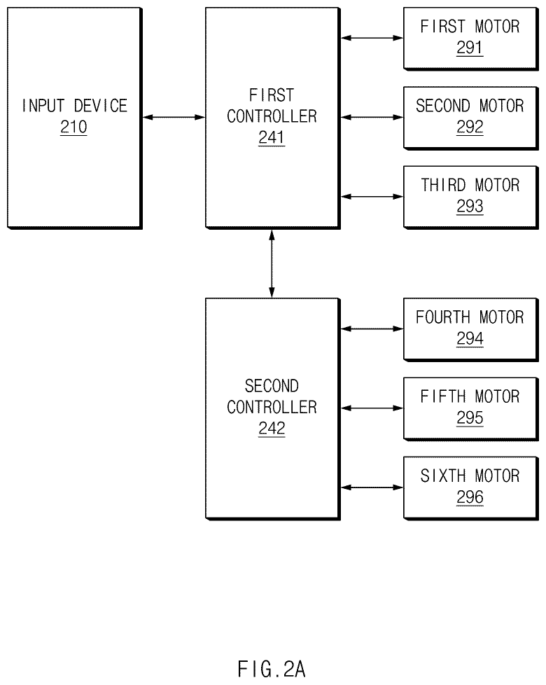

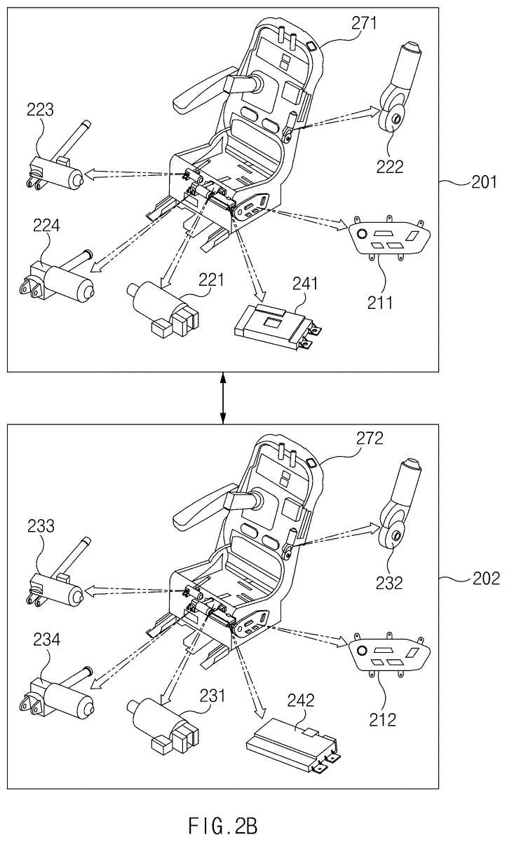

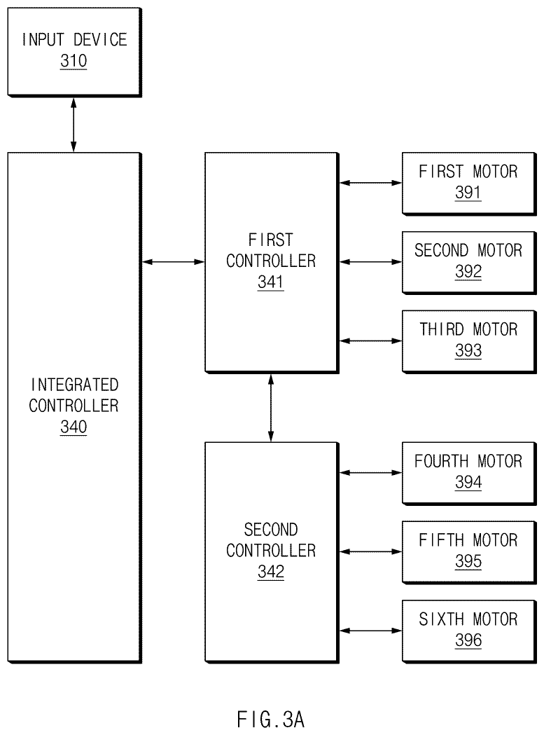

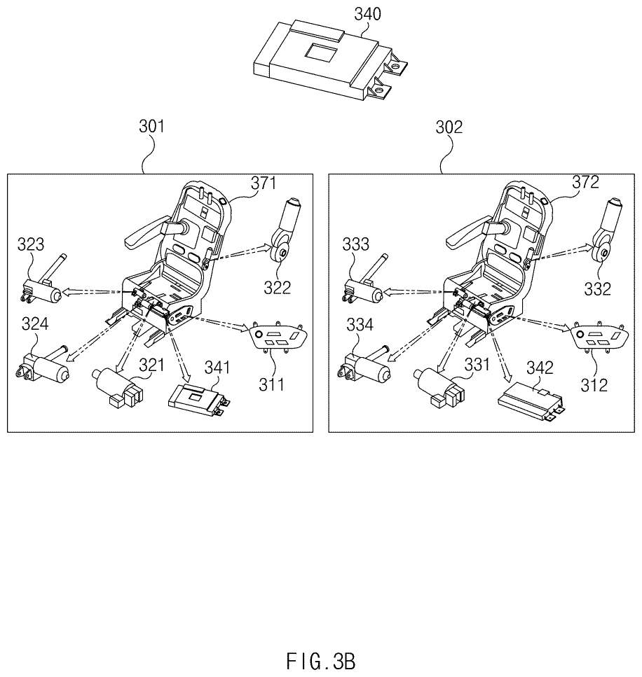

Hereinafter, in a description of FIGS. 2A-3B, different implementations of the seat control apparatus according to an embodiment of the present disclosure are described below. The implementation according to FIGS. 2A and 2B and the implementation according to FIGS. 3A and 3B may be different from each other. These implementation methods are illustrative and the embodiments in the present disclosure are not limited thereto.

FIGS. 2A and 2B are block diagrams illustrating components of the seat control apparatus according to an embodiment of the present disclosure.

According to an embodiment, a seat control apparatus (e.g., the seat control apparatus 100 of FIG. 1) includes at least one of an input device 210 (e.g., the input device 110 of FIG. 1), a first controller 241, a second controller 242, a first motor 291, a second motor 292, a third motor 293, a fourth motor 294, a fifth motor 295, a sixth motor 296, or any combination thereof. For example, the first to third motors 291 to 293 may be components that are included in the first driving device for a position control of the first seat 271. The fourth to sixth motors 294 to 296 may be components that are included in the second driving device for a position control of the second seat 272.

For example, the first controller 241 may be electrically connected to the first motor 291, the second motor 292, and the third motor 293 that are provided for the position control of the first seat 271. The first controller 241 may be further electrically connected to the second controller 242 and the input device 210.

For example, the first controller 241 may receive a specified input from the input device 210. The specified input may include a request to control movement of at least some of the plurality of seats to a specified target position.

For example, the first controller 241 may acquire position information (or state information of the motor acquired through a Hall sensor) from the first motor 291, the second motor 292, and the third motor 293. The first controller 241 may also identify the current position of the first seat 271 based on the acquired position information.

For example, the first controller 241 may identify the current position of the second seat 272 from the second controller 242. The second controller 242 may acquire position information (or state information of the motor acquired through a Hall sensor) from the fourth motor 294, the fifth motor 295, and the sixth motor 296. After identifying the current position of the second seat 272 based on the acquired position information, the second controller 242 may transmit the identified current position to the first controller 241.

For example, the first controller 241 may predict a possibility of a collision occurring while controlling the seats from the current positions to the target positions based on the acquired position information. Based on the prediction result, the first controller 241 may set an operation sequence. The first controller 241 may deliver a driving device control operation request signal to other controllers including the second controller 242 so that the positions are controlled based on the set operation sequence.

Referring to FIG. 2B, according to an embodiment, a first system 201 (or the first driving device) and a second system 202 (or the second driving device) may transmit and receive electrical signals to and from each other.

For example, the first system 201 may include a first seat 271. The first system 201 may include at least one of at least one motor (e.g., a first slide motor 221, a first reclining motor 222, a first tilting motor 223, or a first leg rest motor 224), a first input device 211, the first controller 241, or any combination thereof, for a position control of the first seat 271.

For example, the second system 202 may include a second seat 272. The second system 202 includes at least one of at least one motor (e.g., a second slide motor 231, a second reclining motor 232, a second tilting motor 233, or a second leg rest motor 234), a second input device 212, the second controller 242, or any combination thereof, for a position control of the second seat 272.

FIGS. 3A and 3B are block diagrams illustrating components of a seat control apparatus according to an embodiment of the present disclosure.

According to an embodiment, the seat control apparatus (e.g., the seat control apparatus 100 of FIG. 1) may include an input device 310 (e.g., the input device 110 of FIG. 1), a first controller 341, a second controller 342, a first motor 391, a second motor 392, a third motor 393, a fourth motor 394, a fifth motor 395, a sixth motor 396, an integrated controller 340, or any combination thereof. For example, the first to third motors 391 to 393 may be components that are included in the first driving device for a position control of the first seat 371. For example, the fourth to sixth motors 394 to 396 may be components that are included in the second driving device for a position control of the second seat 372.

For example, the first controller 341 may be electrically connected to the first motor 391, the second motor 392, and the third motor 393 that are provided for a position control of the first seat. The first controller 341 may be further electrically connected to the integrated controller 340, in contrast to the embodiment depicted in FIG. 2A.

For example, the second controller 342 may be electrically connected to the fourth motor 394, the fifth motor 395, and the sixth motor 396 that are provided for a position control of the second seat 372. Unlike the example of FIG. 2A, the second controller 342 may be further electrically connected to the integrated controller 340.

For example, the integrated controller 340 may receive a specified input through the input device 310. The specified input may include a request to control movement of at least some of the plurality of seats to a specified target position. The integrated controller 340, may receive the current positions of the first seat and the second seat 371 and 372 from the first controller 341 and the second controller 342. The integrated controller 240 may identify a target position corresponding to the specified input, and may predict a possibility of collision that will occur between the seats, based on the current position and the target position.

For example, when the setting of an operation sequence is completed based on the collision possibility prediction result, the integrated controller 340 may deliver an operation signal based on the set operation sequence to the first controller 341 and/or the second controller 342.

Referring to FIG. 3B, according to an embodiment, a first system 301 (or the first driving device), a second system 302 (or the second driving device), and the integrated controller 340 may transmit and receive electrical signals to and from each other.

For example, the first system 301 may include a first seat 391. The first system 301 includes at least one of at least one motor (e.g., a first slide motor 321, a first reclining motor 322, a first tilting motor 323, or a first leg rest motor 324), a first input device 311, the first controller 341, or any combination thereof.

For example, the second system 302 may include a second seat 372. The second system 302 includes at least one of at least one motor (e.g., a second slide motor 331, a second reclining motor 332, a second tilting motor 333, or a second leg rest motor 334), a second input device 312, the second controller 342, or any combination thereof, for a position control of the second seat 372.

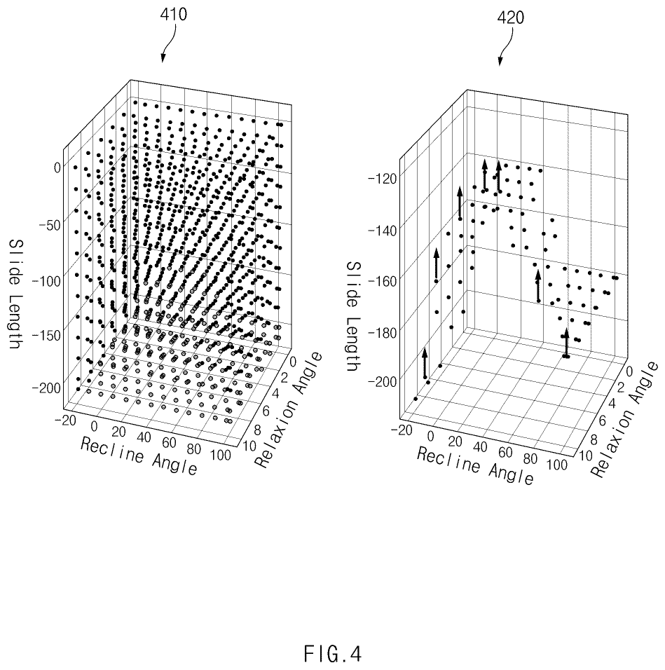

FIG. 4 is a view illustrating a graph used by a seat control apparatus to determine a collision possibility according to an embodiment of the present disclosure.

According to an embodiment, the seat control apparatus (e.g., the seat control apparatus 100 of FIG. 1) may determine a possibility of collision between the seats based on coordinate data regarding the states of the seats.

For example, the seat control apparatus may predict whether a collision will occur between the target seat and the adjacent seat in a process of controlling the target seat from the current state to the target state based on the comparison result of the coordinate data corresponding to the current state of the target seat, the target state, and the current state of the adjacent seat. The coordinate data may include information on a reclining angle (or a backrest angle), a relaxation angle (or a tilting angle), and a slide position.

For example, the graphs according to reference numbers 410 and 420 are graphs depicting a possibility of a collision that occurs depending on the current state of the target seat, assuming that the current state of the adjacent seat is a specific state (e.g., a fully folded state).

For example, the x-axis of the graphs according to reference numbers 410 and 420 may be a reclining angle of the target seat, the y-axis may be a relaxation angle, and the z-axis may be a slide position.

For example, referring to reference number 410, the seat control apparatus may distinguish and identify coordinate data, by which it is expected that a collision will occur between the seats, and coordinate data, by which it is expected that there is no collision.

For example, referring to reference number 420, the seat control apparatus may identify boundary data. In other words, the seat control apparatus may identify boundary data between the coordinate data, by which it is expected that a collision will occur, and the coordinate data, by which it is expected that there is no collision.

The seat control apparatus, for example, may predict a possibility of a collision between the target seat and the adjacent seat based on the identified data. As an example, the seat control apparatus may determine that there is a collision possibility when it is identified that coordinate data based on the current state and the target state of the target seat, and the current state of the adjacent seat are present above the identified boundary data.

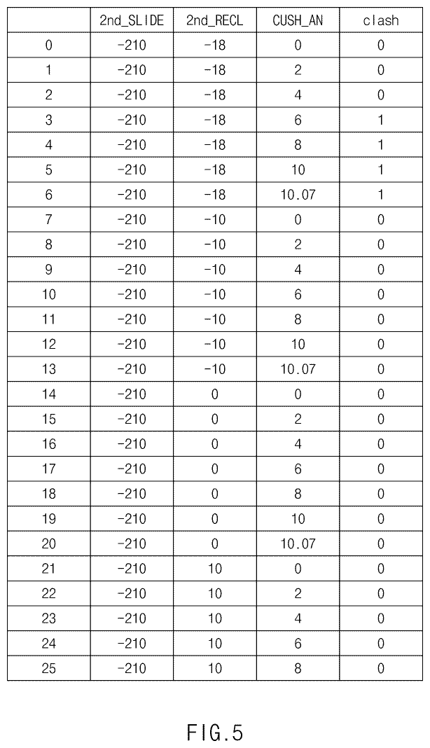

FIG. 5 is a view illustrating a table used by a seat control apparatus to determine a collision possibility according to an embodiment of the present disclosure.

According to an embodiment, the seat control apparatus (e.g., the seat control apparatus 100 of FIG. 1) may store a mapping table in a memory (e.g., the memory 130 of FIG. 1).

The mapping table may include information on the states of the plurality of seats in the host vehicle and whether a collision will occur depending on the states.

Referring to FIG. 5, for example, the mapping table may include information on a slide position, a reclining angle, a cushion angle (or a tilting angle) of a second row seat, and whether a collision will occur.

For example, when the second row seat is the target seat, the seat control apparatus may identify the first current state of the second row seat and the second current state of the adjacent seat (e.g., a first row seat and/or a third row seat). In other words, when the user performs a specified input to control the second row seat to the target state, the seat control apparatus may identify the second row seat as the target seat, and identify the first current state and the second current state.

For example, the seat control apparatus may store target coordinate data corresponding to the target state in the memory. The seat control apparatus, as an example, may identify first coordinate data and second coordinate data corresponding to the first current state and the second current state, respectively. The seat control apparatus may compare them with the target coordinate data to predict a possibility of a collision based on the comparison result.

For example, when it is determined that there is a time point, at which the minimum spacing distance between the target seat and the adjacent seat is a specified distance or less, while the seat control apparatus controls the target seat from the first current state to the target state, the seat control apparatus expects that a collision will occur and may not control the target seat.

For example, the seat control apparatus may identify the state information depending on the first current state of the target seat, based on the first coordinate data.

As an example, referring to the table of FIG. 5, it may be identified that the slide position of the target seat is −210, the reclining angle is −18 degrees, and the cushion angle is 4 degrees. In this case, the seat control apparatus may compare the coordinate data depending on the first current state and the second current state based on the mapping table, and may identify that a value of a clash column is 0 based on the comparison result. Accordingly, the seat control apparatus may predict that the target seat will not collide with the adjacent seat while controlling from the first current state to the target state.

As an example, referring to the table of FIG. 5, the seat control apparatus may compare the coordinate data depending on the first current state and the second current state based on the mapping table. For example, it may be identified that the slide position of the target seat is −210, the reclining angle is −18 degrees, and the cushion angle is 6 degrees. In this case, the seat control apparatus may identify that the value of the clash column is 1 based on the comparison result. Accordingly, the seat control apparatus may predict that the target seat will collide with the adjacent seat while controlling from the first current state to the target state.

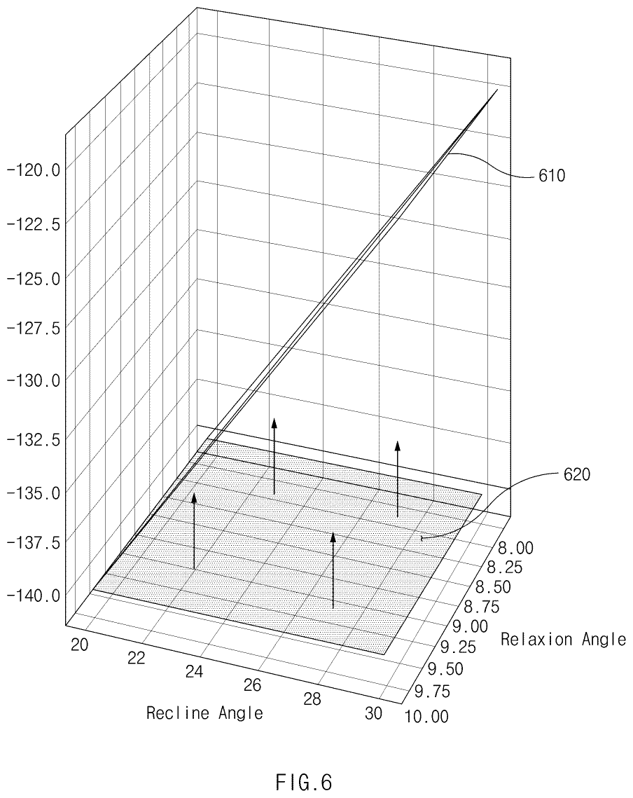

FIG. 6 is a view illustrating a graph used by a seat control apparatus to determine a collision possibility according to an embodiment of the present disclosure.

According to an embodiment, the seat control apparatus (e.g., the seat control apparatus 100 of FIG. 1) may identify a possibility of a collision in the process of controlling the seat by using the mapping table based on a 3-dimensional graph according to FIG. 6.

For example, the seat control apparatus may extract at least one coordinate data from the coordinate data stored in the mapping table. As an example, the seat control apparatus may identify a first coordinate (a11, b11, c11), a second coordinate (a11, b12, c12), a third coordinate (a12, b11, c13), and a fourth coordinate (a12, b12, c14). For example, when c11, c12, and c13 are less than or equal to c14, and any one of the first to fourth coordinates is identified as a coordinate, at which a collision is likely to occur, a boundary value of the z axis is set to c14. The set boundary section may be denoted by reference number 610.

For example, the seat control apparatus may extract at least one coordinate data from the coordinate data stored in the mapping table. As an example, the seat control apparatus may identify a fifth coordinate (a21, b21, c21), a sixth coordinate (a21, b22, c22), a seventh coordinate (a22, b21, c23), and an eighth coordinate (a22, b22, c24). The fifth to sixth coordinates may correspond to a point, at which it is expected that a collision occurs, and may correspond to a boundary point with an area, in which it is expected that no collision will occur. In this case, the seat control apparatus may identify a plane 620 that passes through the fifth to sixth coordinates. For example, the seat control apparatus may identify an equation of the plane 620 based on the fifth to sixth coordinates. Based on this, the seat control apparatus may predict whether a collision possibility is present from other coordinate data.

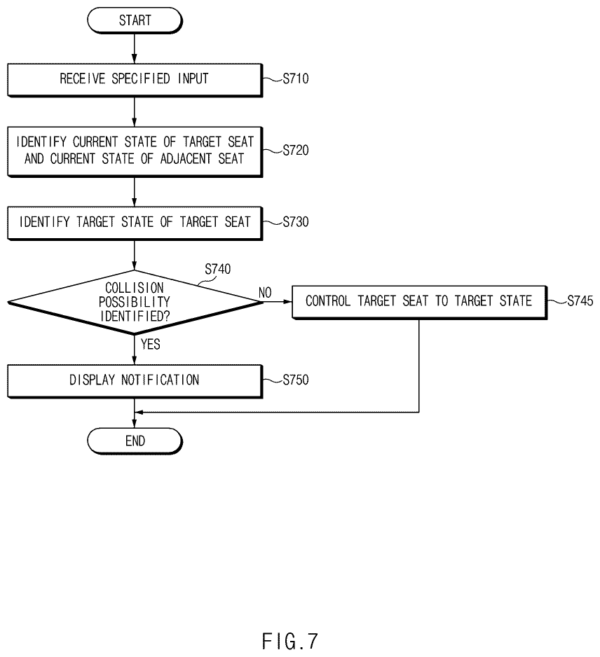

FIG. 7 is a flowchart describing a seat control method according to an embodiment of the present disclosure.

According to an embodiment, a seat control apparatus (e.g., the seat control apparatus 100 of FIG. 1) may perform the operations disclosed in FIG. 7. For example, at least some of the components included in the seat control apparatus (e.g., the input device 110, the driving device 120, the memory 130, the controller 140, and the output device 150 of FIG. 1) may be set to perform the operations of FIG. 7.

In the following embodiments, operations S710 to S750 may be performed sequentially, but are not necessarily performed sequentially. For example, the orders of the operations may be changed, and at least two operations may be performed in parallel. Furthermore, contents that correspond to or overlap the contents described above in relation to FIG. 7 have been briefly described or omitted.

According to an embodiment, the seat control apparatus may receive a specified input (S710).

For example, the seat control apparatus may receive a specified input from the user who requests to control the target seat to the target state by using the input device.

According to an embodiment, the seat control apparatus may identify the current state of the target seat and the current state of the adjacent seat (S720).

For example, the seat control apparatus may identify a first current state, which is a real-time state of the target seat, and a second current state, which is a real-time state of the adjacent seat (e.g., the front seat and/or the rear seat of the target seat).

For example, the current state may include the slide position, the reclining angle, and/or the cushion angle of the seat.

According to an embodiment, the seat control apparatus may identify the target state of the target seat (S730).

For example, the seat control apparatus may identify the target coordinate data corresponding to the target state.

According to an embodiment, the seat control apparatus may identify a collision possibility (S740).

For example, the seat control apparatus may predict whether a collision with the adjacent seat will occur in the process of controlling the target seat from the first current state to the target state.

For example, the seat control apparatus may predict the possibility of a collision based on a comparison result between the first current state, the second current state, and/or the target state.

For example, the seat control apparatus may predict that there is a collision possibility when determining that there is a time point, at which the minimum spacing distance between the target seat and the adjacent seat is less than or equal to the first distance in the process of controlling the target seat.

For example, when predicting that a collision will occur (e.g., operation S740-Yes), the seat control apparatus may perform operation S750.

For example, when predicting that a collision will not occur (e.g., operation S740-No), the seat control apparatus may perform operation S745.

According to an embodiment, the seat control apparatus may control the target seat to the target state (S745).

According to an embodiment, the seat control apparatus may display a notification (S750).

For example, the seat control apparatus may provide the user with information that a collision with the adjacent seat is predicted to occur when controlling the target seat to the target state.

For example, the seat control apparatus may provide a notification regarding disabling of the target seat by using the output device.

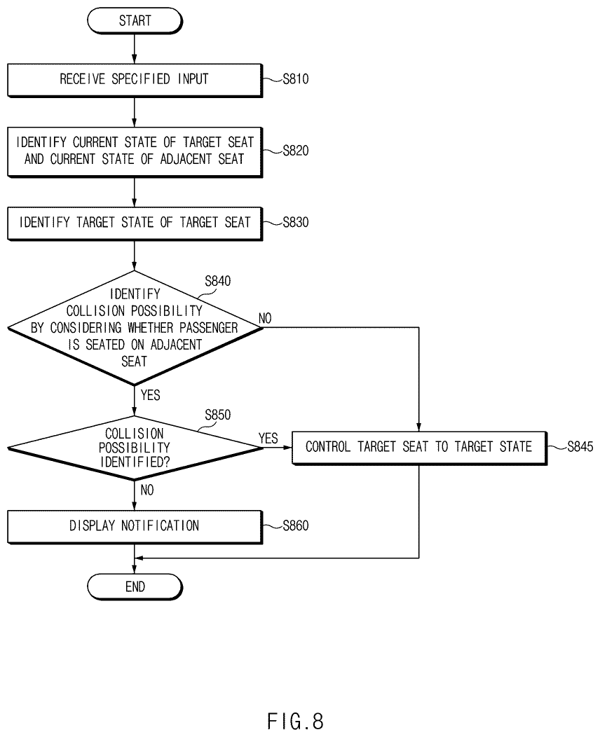

FIG. 8 is a flowchart describing a seat control method according to an embodiment of the present disclosure.

According to an embodiment, a seat control apparatus (e.g., the seat control apparatus 100 of FIG. 1) may perform the operations disclosed in FIG. 8. For example, at least some of the components included in the seat control apparatus (e.g., the input device 110, the driving device 120, the memory 130, the controller 140, and the output device 150 of FIG. 1) may be set to perform the operations of FIG. 8.

In the following embodiments, operations S810 to S860 may be performed sequentially, but are not necessarily performed sequentially. For example, the orders of the operations may be changed, and at least two operations may be performed in parallel. Furthermore, contents that correspond to or overlap the contents described above in relation to FIG. 8 have been briefly described or omitted. For example, a description of operations S810 to S830 of FIG. 8 may be replaced by the description of operations S710 to S730 of FIG. 7 described above.

According to an embodiment, the seat control apparatus may identify a collision possibility by considering whether a passenger is seated on the adjacent seat (S840).

For example, unlike the embodiment of FIG. 7 described above, upon identifying that a passenger is seated on the adjacent seat, the seat control apparatus may predict that there is a collision possibility when it is determined that a time point, at which the minimum spacing distance between the target seat and the adjacent seat is less than and equal to a second distance that is smaller than the first distance.

Unlike the above example, upon identifying that a passenger is seated on the adjacent seat, the seat control apparatus may not control the target seat without identifying the collision possibility.

For example, when predicting that a collision will occur (e.g., operation S840-Yes), the seat control apparatus may perform operation S850.

For example, when predicting that a collision will not occur (e.g., operation S840-No), the seat control apparatus may perform operation S845.

According to an embodiment, the seat control apparatus may identify the target state of the adjacent seat to eliminate the collision possibility (S850).

For example, the seat control apparatus may identify a predefined avoidance state of the adjacent seat and identify whether a collision does not occur when controlling the target seat to the target state after controlling the adjacent seat to the avoidance state.

For example, when identifying the target state of the adjacent seat to avoid a collision (e.g., operation S850-Yes), the seat control apparatus may perform operation S845.

For example, when the target state of the adjacent seat to avoid a collision is not identified (or when it is predicted that a collision will occur even when the adjacent seat is controlled by the target state) (e.g., operation S850-No), the seat control apparatus performs operation S860.

According to an embodiment, the seat control apparatus may control the target seat to the target state (S845).

For example, the seat control apparatus may control the target seat to the target state corresponding to the specified input after controlling the adjacent seat to the identified target state.

According to an embodiment, the seat control apparatus may display a notification (S860).

For example, the seat control apparatus may provide the user with information indicating that it is predicted that a collision with the adjacent seat will occur when controlling the target seat to the target state.

For example, the seat control apparatus may provide a notification regarding the disabling of the target seat by using the output device.

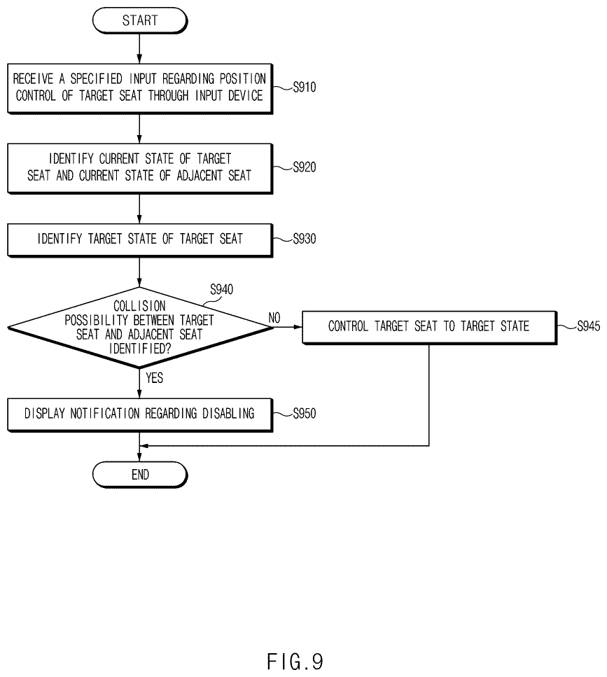

FIG. 9 is a flowchart describing a seat control method according to an embodiment of the present disclosure.

According to an embodiment, a seat control apparatus (e.g., the seat control apparatus 100 of FIG. 1) may perform the operations disclosed in FIG. 9. For example, at least some of the components included in the seat control apparatus (e.g., the input device 110, the driving device 120, the memory 130, the controller 140, and the output device 150 of FIG. 1) may be set to perform the operations of FIG. 9.

In the following embodiments, operations S910 to S950 may be performed sequentially, but are not necessarily performed sequentially. For example, the orders of the operation may be changed, and at least two operations may be performed in parallel. Furthermore, contents that corresponds to or overlap the contents described above in relation to FIG. 9 have been briefly described or omitted.

According to an embodiment, the seat control apparatus may receive a specified input (S910).

According to an embodiment, the seat control apparatus may identify the current states of the target seat and the adjacent seat (S920).

For example, the seat control apparatus may identify the first current state of the target seat and the second current state of the adjacent seat.

According to an embodiment, the seat control apparatus may identify the target state of the target seat (S930).

For example, the seat control apparatus may identify the target coordinate data of the target state corresponding to the specified input.

According to an embodiment, the seat control apparatus may identify the possibility of a collision between the target seat and the adjacent seat (S940).

For example, the seat control apparatus may predict the collision possibility of the target seat and the adjacent seat while controlling the target seat from the first current state to the target state based on a comparison result of the first current state, the second current state, and/or the target state.

For example, when it is predicted that a collision will occur (e.g., operation S940-Yes), the seat control apparatus may perform operation S950.

For example, when predicting that a collision will not occur (e.g., operation S940-No), the seat control apparatus may perform operation S945.

According to an embodiment, the seat control apparatus may control the target seat to the target state (S945).

According to an embodiment, the seat control apparatus may display a notification (S950).

For example, the seat control apparatus may provide the user with information indicating that it is predicted that a collision with the adjacent seat will occur when controlling the target seat to the target state.

For example, the seat control apparatus may provide a notification regarding the disabling of the target seat by using the output device.

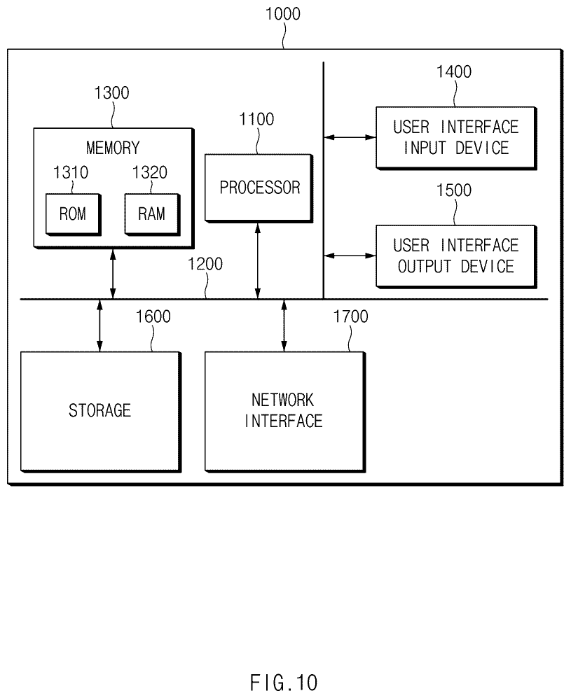

FIG. 10 illustrates a computing system related to a seat control apparatus or a seat control method according to an embodiment of the present disclosure.

Referring to FIG. 10, a computing system 1000 regarding the seat control method may include at least one processor 1100, a memory 1300, a user interface input device 1400, a user interface output device 1500, storage 1600, and a network interface 1700, which are connected through a bus 1200.

The processor 1100 may be a central processing unit (CPU), or a semiconductor device that processes instructions stored in the memory 1300 and/or the storage 1600. The memory 1300 and the storage 1600 may include various volatile or nonvolatile storage media. For example, the memory 1300 may include a read only memory (ROM) and a random access memory (RAM).

Accordingly, the steps of the method or algorithm described in relation to the embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an Erasable Programmable Read-Only Memory (EPROM), an Electrically Erasable Programmable Read-Only Memory (EEPROM), a register, a hard disk, a solid state drive (SSD), a detachable disk, or a CD-ROM.

The storage medium is coupled to the processor 1100, and the processor 1100 may read information from the storage medium and may write information in the storage medium. In another method, the storage medium may be integrated with the processor 1100. The processor and the storage medium may reside in an application specific integrated circuit (ASIC). The ASIC may reside in a user terminal. In another method, the processor and the storage medium may reside in the user terminal as an individual component.

The effects of the seat control apparatus and the seat control method according to the present disclosure are described as follows.

According to the embodiments of the present disclosure, when a specified input is received from a user, a current state of an adjacent system (e.g., a front seat or a rear seat) of a dynamic system (e.g., a seat) corresponding to the specified input may be identified and a collision possibility that may occur in a process of controlling it to a target state corresponding to the specified input may be controlled.

According to the embodiments of the present disclosure, coordinate data corresponding to current states of a target seat and an adjacent seat and coordinate data corresponding to a target state may be identified based on a mapping table stored in a memory. Additionally, a collision possibility may be predicted based on a comparison result of the coordinate data.

According to the embodiments of the present disclosure, when coordinate data corresponding to a current state is not identified based on a mapping table, a collision possibility may be predicted based on reference data that are closest to the current state.

According to the embodiments of the present disclosure, when it is identified that a passenger is seated on an adjacent seat, a collision possibility may be predicted based on another reference that is different from that of a case in which no passenger is seated.

In addition, various effects that may be directly or indirectly recognized through this document may be provided.

The above description is a simple illustrative description of the technical spirit of the present disclosure. The present disclosure may be variously modified and altered by a person having ordinary skill in the art, to which the present disclosure pertains, without departing from the essential characteristics of the present disclosure.

Therefore, the embodiments of the present disclosure are provided to explain the spirit and scope of the present disclosure, but not to limit them. Thus, the spirit and scope of the present disclosure is not limited by the embodiments. The scope of the present disclosure should be construed based on the accompanying claims, and all the technical ideas within the scope equivalent to the claims should be included in the scope of the present disclosure.

What is claimed is:

1. A seat control apparatus comprising:
an input device;
a driving device;
a memory configured to store one or more instructions; and
a controller operatively connected to the input device, the driving device, and the memory,
wherein the instructions are configured to, when being executed by the controller, cause the seat control apparatus to:
identify a first current state of a target seat and a second current state of an adjacent seat upon receiving a specified input regarding a position of the target seat through the input device;
identify a target state of the target seat corresponding to the specified input;
predict a collision possibility of the target seat and the adjacent seat while the target seat is controlled from the first current state to the target state, based on the first current state, the second current state, and the target state; and
control the target seat to the target state by using the driving device upon identifying that there is no collision possibility.

2. The seat control apparatus of claim 1, wherein the instructions are configured to, when being executed by the controller, cause the seat control apparatus to:
identify first coordinate data of the target seat and second coordinate data of the adjacent seat including at least one of reclining angles, slide positions, folding angles, tilting angles of the target seat and the adjacent seat, or any combination thereof, respectively; and
predict the collision possibility based on a comparison result of the first coordinate data and the second coordinate data.

3. The seat control apparatus of claim 2, wherein the instructions are configured to, when being executed by the controller, cause the seat control apparatus to:
determine that there is a collision possibility when a minimum spacing distance between the target seat and the adjacent seat is a first distance or less while controlling the target seat to the target state, based on the comparison result.

4. The seat control apparatus of claim 2, wherein the instructions are configured to, when being executed by the controller, cause the seat control apparatus to:
identify the first coordinate data and the second coordinate data from a mapping table stored in the memory, based on the first current state and the second current state.

5. The seat control apparatus of claim 4, wherein the instructions are configured to, when being executed by the controller, cause the seat control apparatus to:
identify first reference data and second reference data having the first current state as an intermediate value, from the mapping table when not identifying the first coordinate data from the mapping table; and
identify the collision possibility based on a comparison result of the first reference data, the second reference data, the second coordinate data, and the target state.

6. The seat control apparatus of claim 1, wherein the instructions are configured to, when being executed by the controller, cause the seat control apparatus to:
control the adjacent seat to a specified state and predict the collision possibility again based on the first current state, the specified state, and the target state upon identifying that there is the collision possibility.

7. The seat control apparatus of claim 6, wherein the instructions are configured to, when being executed by the controller, cause the seat control apparatus to:
identify, among avoidance coordinates set not to collide, an avoidance coordinate being closest to the specified state, based on a mapping table stored in the memory, upon identifying that there is the collision possibility;
control the adjacent seat based on the avoidance coordinate; and
control the target seat to the target state.

8. The seat control apparatus of claim 1, further comprising:
an output device,
wherein the instructions are configured to, when being executed by the controller, cause the seat control apparatus to:
provide a notification regarding disabling of an operation of the target seat by using the output device upon identifying that there is the collision possibility.

9. The seat control apparatus of claim 3, further comprising:
an output device,
wherein the instructions are configured to, when being executed by the controller, cause the seat control apparatus to:
provide a warning notification by using the output device upon identifying that a passenger is seated on the adjacent seat; and
identify the first current state and the second current state upon receiving an operation request corresponding to the warning notification.

10. The seat control apparatus of claim 9, wherein the instructions are configured to, when being executed by the controller, cause the seat control apparatus to:
determine that there is the collision possibility when predicting that a time point, at which the minimum spacing distance is not more than a second distance that is smaller than the first distance, is present.

11. A seat control method comprising:
identifying, by a controller, a first current state of a target seat and a second current state of an adjacent seat upon receiving a specified input regarding a position of the target seat through an input device;
identifying, by the controller, a target state of the target seat corresponding to the specified input;
predicting, by the controller, a collision possibility of the target seat and the adjacent seat while the target seat is controlled from the first current state to the target state, based on the first current state, the second current state, and the target state; and
controlling, by the controller, the target seat to the target state by using a driving device upon identifying that there is no collision possibility.

12. The seat control method of claim 11, further comprising:
identifying, by the controller, first coordinate data of the target seat and second coordinate data of the adjacent seat including at least one of reclining angles, slide positions, folding angles, tilting angles of the target seat and the adjacent seat, or any combination thereof, respectively; and
predicting, by the controller, the collision possibility based on a comparison result of the first coordinate data and the second coordinate data.

13. The seat control method of claim 12, further comprising:
determining, by the controller, that there is a collision possibility when a minimum spacing distance between the target seat and the adjacent seat is a first distance or less while controlling the target seat to the target state, based on the comparison result.

14. The seat control method of claim 12, further comprising:
identifying, by the controller, the first coordinate data and the second coordinate data from a mapping table stored in a memory, based on the first current state and the second current state.

15. The seat control method of claim 14, further comprising:
identifying first reference data and second reference data having the first current state as an intermediate value, from the mapping table when not identifying the first coordinate data from the mapping table; and
identifying, by the controller, the collision possibility based on a comparison result of the first reference data, the second reference data, the second coordinate data, and the target state.

16. The seat control method of claim 11, further comprising:
controlling, by the controller, the adjacent seat to a specified state and predicting the collision possibility again based on the first current state, the specified state, and the target state upon identifying that there is the collision possibility.

17. The seat control method of claim 16, further comprising:
identifying, by the controller, among avoidance coordinates set not to collide, an avoidance coordinate being closest to the specified state, based on a mapping table stored in a memory, upon identifying that there is the collision possibility; and
controlling, by the controller, the adjacent seat based on the avoidance coordinate; and
controlling, by the controller, the target seat to the target state.

18. The seat control method of claim 11, further comprising:
providing, by the controller, a notification regarding disabling of an operation of the target seat by using an output device upon identifying that there is the collision possibility.

19. The seat control method of claim 13, further comprising:
providing, by the controller, a warning notification by using an output device upon identifying that a passenger is seated on the adjacent seat; and
identifying, by the controller, the first current state and the second current state upon receiving an operation request corresponding to the warning notification.

20. The seat control method of claim 19, further comprising:
determining, by the controller, that there is the collision possibility when predicting that a time point, at which the minimum spacing distance is not more than a second distance that is smaller than the first distance, is present.
